(19) United States
(12) Patent Application Publication
(10) Pub. No.: US 2013/0056192 A1
(43) Pub. Date: Mar. 7, 2013

(54) HEAT DISSIPATION DEVICE WITH FASTENER

(71) Applicant: CHIH-PENG LEE, Tu-Cheng (TW)

(72) Inventor: CHIH-PENG LEE, Tu-Cheng (TW)

(73) Assignee: FOXCONN TECHNOLOGY CO., LTD., Tu-Cheng (TW)

(21) Appl. No.: 13/287,126

(22) Filed: Nov. 2, 2011

(30) Foreign Application Priority Data
Sep. 5, 2011 (TW) 100131976

(51) Int. Cl. F28F 7/00; F16B 21/09

(52) U.S. Cl. 165/185; 411/349

(57) ABSTRACT

An exemplary heat dissipation device includes a conductive plate and a fastener. The fastener includes a fastening element and a spring coiled around the fastening element. The fastening element includes a pole portion, a head portion, and an engaging portion. The conductive plate has a through hole defined therein. An inner face defining the through hole includes a first face and a second face which have different curvatures. A flange protrudes from a circumference of the pole portion adjacent to the engaging portion. The structure of the flange matches the configuration of the through hole. After the flange extends through the through hole from a side of the conductive plate, the flange is rotated an angle and buckled at another opposite side of the conductive plate. The spring is compressed between the head portion and the conductive plate.

### BACKGROUND

1. Technical Field

The disclosure relates to heat dissipation devices and, more particularly, to a heat dissipation device with a fastener for fastening the heat dissipation device on a printed circuit board.

2. Description of Related Art

It is well known that, during operation of a computer, electronic devices such as central processing units (CPUs) frequently generate large amounts of heat. The heat must be quickly removed from the electronic device to prevent it from becoming unstable or being damaged. Typically, a heat sink is attached to an outer surface of the electronic device to absorb heat from the electronic device. The heat absorbed by the heat sink is then dissipated to ambient air.

In order to keep the heat sink in intimate contact with the electronic device, a fastener extends through the heat sink and a printed circuit board where the electronic device is located to fasten the heat sink to the electronic device. However, before the heat sink mounted on the electronic device, the fastener is usually pre-assembled on the heat sink by an annular collar which snaps with an end of the fastener extending beyond the heat sink, for facilitating transportation. However, the collar is prone to disengage from the fastener when subjected to an outer force during transportation, resulting in falling of the fastener from the heat sink.

What is needed, therefore, is a heat dissipation device with a fastener which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of a heat dissipation device in accordance with an embodiment of the disclosure.

FIG. 2 is an exploded view of the heat dissipation device of FIG. 1.

FIG. 3 is an inverted view of the heat dissipation device of FIG. 1, wherein a fastener of the heat dissipation device is in a released position.

FIG. 4 is a view similar to FIG. 3, wherein the fastener of the heat dissipation device is in a locked position.

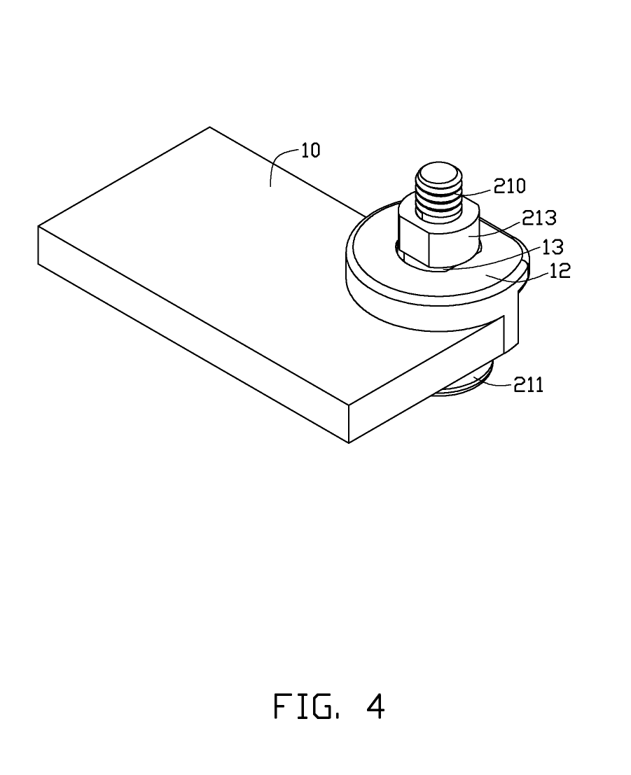

### DETAILED DESCRIPTION

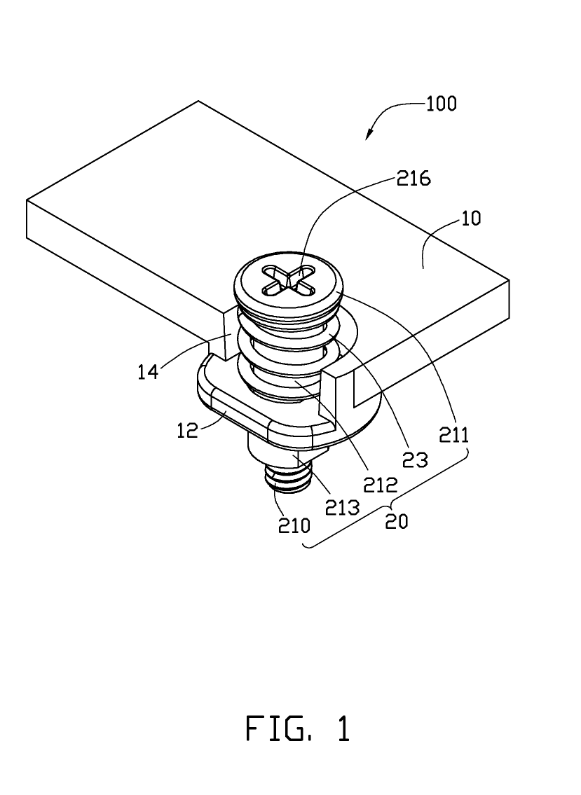

Referring to FIG. 1, a heat dissipation device 100 in accordance with an embodiment of the disclosure is shown. The heat dissipation device 100 is for dissipating heat generated by an electronic device (not shown) mounted on a printed circuit board (not shown). The heat dissipation device 100 includes a conductive plate 10, and a fastener 20 for fastening the heat dissipation device 100 on the printed circuit board.

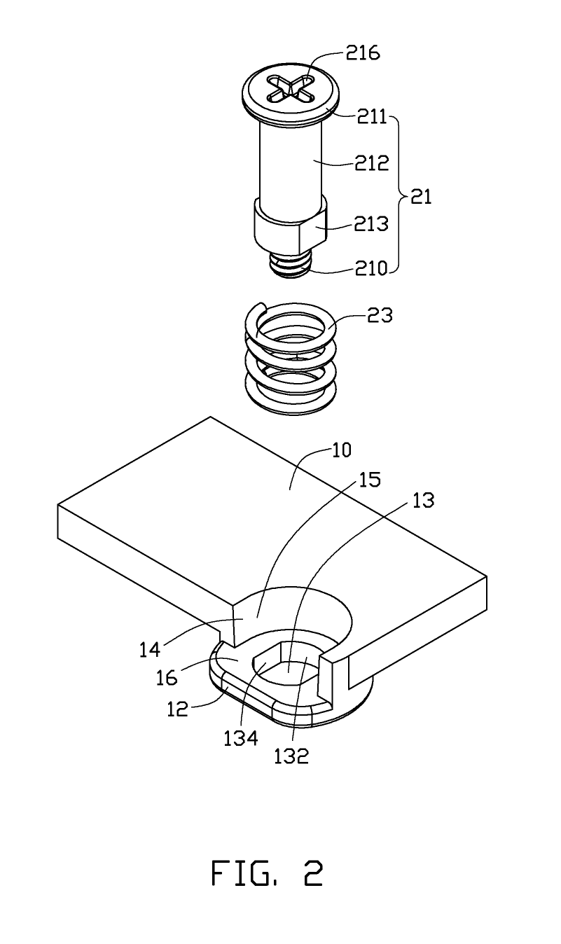

Also referring to FIG. 2, the conductive plate 10 defines a semicircular cutout 14 near a corner thereof. A plate-shaped supporting portion 12 is formed at a bottom of the conductive plate 10 corresponding to the cutout 14. A part of the supporting portion 12 extends horizontally beyond the cutout 14 of the conductive plate 10. The supporting portion 12 defines a through hole 13 in a center thereof. The conducting plate 10 forms a sidewall 15 defining the cutout 14. The through hole 13 is beneath the cutout 14. A step 16 is formed at a bottom of the cutout 14 and around the through hole 13. The sidewall 15 connects with the step 16. An inner face of the supporting portion 12 defining the through hole 13 includes a first face and a second face which have different curvatures. The first face includes two opposite arc faces 132, and the second face includes two parallel planes 134 located between the arc faces 132.

The fastener 20 comprises a fastening element 21, and a spring 23 circling the fastening element 21. The fastening element 21 comprises a column-shaped pole portion 212, a circular head portion 211 extending from a top end of the pole portion 212, and a column-shaped engaging portion 210 extending from an opposite bottom end of the pole portion 212.

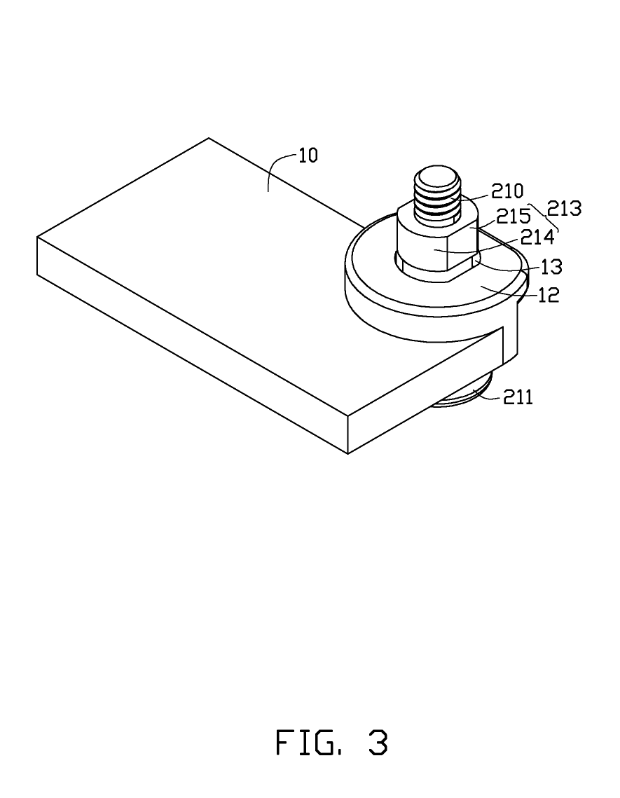

Also referring to FIG. 3, the engaging portion 210 is columned and defines a plurality of threads on a periphery thereof. The pole portion 212 has a diameter larger than that of the engaging portion 210. The head portion 211 defines an operating groove 216 in a top face thereof for facilitating operation of a tool such as a screwdriver to fasten the fastener 20 to the printed circuit board. The head portion 211 has a diameter larger than that of an inner diameter of the spring 23.

A flange 213 protrudes horizontally and outwardly from a periphery of the pole portion 212 adjacent to the engaging portion 210. The flange 213 includes two opposite arc faces 214 and two parallel planes 215 located between the arc faces 214. The arc faces 214 and the planes 215 of the flange 213 are interconnected and corporately construct a side face of the flange 213. The arc faces 214 of the flange 213 are respectively corresponding to the arc faces 132 of the conductive plate 10. The planes 215 of the flange 213 are respectively corresponding to the planes 134 of the conductive plate 10. Each of the planes 215 intersects a circumferential side face of the pole portion 212. The structure of the flange 213 matches the configuration of the through hole 13 of the conductive plate 10. That is, profile and size of the flange 213 are identical to profile and size of the through hole 13 of the conductive plate 10. The diameters of the pole portion 212 and the flange 213 are smaller than the inner diameter of the spring 23.

In assembly, the flange 213 extends through the spring 23, so that the spring 23 is sleeved on the pole portion 212 of the fastening element 21. The flange 213 of the fastening element 21 then extends down through the through hole 13, so the flange 213 and the spring 23 are respectively located at two opposite sides of the supporting portion 12 of the conductive plate 10, wherein, when the flange 213 is in the through hole 13, the arc faces 214 of the flange 213 are corresponding to the arc faces 132 of the inner face of the conductive plate 10. The flange 213 is then horizontally rotated about 90 degrees to make the arc faces 214 of the flange 213 abut the conductive plate 10 at positions corresponding to the parallel planes 134 around the through hole 13, here, the planes 215 of the flange 213 are corresponding to the arc faces 132 of the inner face of the conductive plate 10. The spring 23 is compressed between the head portion 211 of the fastening element 21 and the step 16 of the supporting portion 12 of the conductive plate 10. Thus, the fastener 20 is securely fastened on the conductive plate 10 and is embayed by the sidewall 15 on the step 16.

It is believed that the disclosure and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat dissipation device, comprising:
a conductive plate defining a through hole therein, an inner face of the conductive plate defining the through hole comprising a first face and a second face, the first and second faces having different curvatures; and
a fastener comprising a fastening element and a spring coiling around the fastening element, the fastening element comprising a column-shaped pole portion, a head portion formed at one end of the pole portion, an engaging portion formed at another opposite end of the pole portion, and a flange protruding from a circumference of the pole portion adjacent to the engaging portion, the structure of the flange matching the configuration of the through hole of the conductive plate, the flange extending through the through hole from a side of the conductive plate and then being rotated an angle to be buckled at another opposite side of the conductive plate; the spring being compressed between the head portion of the fastening element and the conductive plate.

2. The heat dissipation device of claim 1, wherein the first face is an arc face, and the second face is a plane.

3. The heat dissipation device of claim 1, wherein the first face comprises two opposite arc faces, and the second face comprises two parallel planes located between the arc faces.

4. The heat dissipation device of claim 1, wherein the engaging portion is column-shaped and defines a plurality of threads on a periphery thereof.

5. The heat dissipation device of claim 1, wherein the head portion defines an operating groove for facilitating operation of a tool.

6. The heat dissipation device of claim 1, wherein the head portion has an outer diameter larger than an inner diameter of the spring.

7. The heat dissipation device of claim 1, wherein the flange comprises two opposite arc faces, and two parallel planes located between the arc faces, the arc faces and the planes of the flange being interconnected and corporately constructing a side face of the flange.

8. The heat dissipation device of claim 7, wherein each of the planes of the flange intersects a circumferential side face of the pole portion.

9. The heat dissipation device of claim 1, wherein an outer diameter of each of the pole portion and the flange is smaller than an inner diameter of the spring.

10. The heat dissipation device of claim 1, wherein the flange extends through the spring, the spring being sleeved on the pole portion of the fastening element.

11. The heat dissipation device of claim 1, wherein the conductive plate defines a cutout near a corner thereof, a plate-shaped supporting portion being formed at a bottom of the conductive plate corresponding to the cutout, the through hole being defined in a center of the supporting portion and beneath the cutout.

12. The heat dissipation device of claim 11, wherein a part of the supporting portion extends horizontally beyond the cutout of the conductive plate.

13. The heat dissipation device of claim 11, wherein the conducting plate forms a sidewall defining the cutout, a step being formed at a bottom of the cutout and around the through hole, the sidewall connecting the step.

14. A heat dissipation device, comprising:
a conductive plate defining a through hole therein, an inner face of the conductive plate defining the through hole comprising a first face and a second face, the first and second faces having different curvatures; and
a fastener comprising a column-shaped pole portion, a head portion extending from one end of the pole portion, an engaging portion extending from another opposite end of the pole portion, and a flange protruding from a circumference of the pole portion adjacent to the engaging portion, profile of the flange being identical to profile of the through hole of the conductive plate, the flange extending through the through hole from a side of the conductive plate and then being rotated an angle to be buckled at another opposite side of the conductive plate.

15. The heat dissipation device of claim 14, wherein the first face comprises two opposite arc faces, and the second face comprises two parallel planes located between the arc faces.

16. The heat dissipation device of claim 15, wherein a side face of the flange comprises two opposite arc faces, and two parallel planes located between the arc faces.

17. The heat dissipation device of claim 16, wherein the arc faces of the flange are corresponding to the arc faces of the inner face of the conductive plate respectively, when the flange is in the through hole of the conductive plate.

18. The heat dissipation device of claim 17, wherein the arc faces of the flange are corresponding to the planes of the inner face respectively, when the flange buckles the conductive plate under through hole.

19. The heat dissipation device of claim 16, wherein each of the planes of the flange intersects a circumferential side face of the pole portion.

20. A fastener comprising:
a column-shaped pole portion;
a head formed at one end of the pole portion, the head being larger than the pole portion in diameter;
an engaging portion formed at an opposite end of the pole portion adapted for fixing the fastener to other element; and
a flange protruding outwards from the opposite end of the pole portion, the flange comprising a first outer face and a second outer face, the first and second outer faces having different curvatures.
